(19) United States
(12) Patent Application Publication
(10) Pub. No.: US 2025/0110973 A1
(43) Pub. Date: Apr. 3, 2025

(54) NEURAL NETWORK FOR EVENT PREDICTION

(71) Applicant: Royal Bank of Canada, Toronto (CA)

(72) Inventors: Qi YAN, Vancouver (CA); Raihan SERAJ, Montreal (CA); Jiawei HE, Vancouver (CA); Lili MENG, Vancouver (CA); Tristan SYLVAIN, Montreal (CA)

(21) Appl. No.: 18/892,241

(22) Filed: Sep. 20, 2024

Related U.S. Application Data
(60) Provisional application No. 63/541,205, filed on Sep. 28, 2023.

(51) Int. Cl. G06F 16/332; G06F 16/33

(52) U.S. Cl. CPC G06F 16/3326; G06F 16/3347

(57) ABSTRACT

Systems and methods for performing event prediction by: receiving an event prediction query, retrieving documents comprising information pertaining to the event prediction query, processing the documents to determine a relevance of the documents to the event prediction query, and generating an input article using the documents and the event prediction query. A decoder comprising a neural network then decodes the input vector into an event prediction outcome. The documents may be news articles. This core method may be supplemented in any one or more ways, such as by using a reward, using one or more large language models to summarize the training documents, and segmenting questions with numeric answers from those with non-numeric answers.

### CROSS-REFERENCE TO RELATED APPLICATIONS

The present application claims priority to U.S. provisional patent application No. 63/541,205, filed on Sep. 28, 2023 and entitled, “Neural Network for Event Prediction”, the entirety of which is hereby incorporated by reference herein.

### TECHNICAL FIELD

The present disclosure is directed at a neural network for event prediction. More particularly, the present disclosure is directed at training at least one neural network for event prediction, and at using the trained at least one neural network for event prediction.

### BACKGROUND

Forecasting future events holds significant practical importance, serving as a valuable tool for tasks like economic management and anticipating customer demands. Accurate forecasting in the real world often requires a multifaceted approach, particularly within a multi-modal context. Human super-forecasters, for example, leverage various information sources, including news articles and diverse data streams, to continually refine their predictions.

In response to this need, the Autocast dataset [2] was developed. This dataset contains a collection of forecasting questions and answers, intertwined with human forecasts and relevant news articles. While machine learning models have made progress in predicting real-life events, the baseline results on this dataset indicate that their performance currently lags behind human expertise.

### SUMMARY

According to a first aspect, there is provided a method for training at least one neural network to perform event prediction, the method comprising: obtaining a training dataset, wherein the training dataset comprises an event forecasting question and a corresponding event forecasting answer representative of a human answer to the event forecasting question; obtaining at least one training document pertinent to the event forecasting question; encoding, using an encoder comprising part of the at least one neural network, the event forecasting question and the at least one training document into an input vector; and decoding, using a decoder comprising part of the at least one neural network, the input vector into a predicted event outcome. The at least one training document may comprise at least one news article. This method may be supplemented in any one or more ways as described below.

For example, supplementing the method may comprise determing a reward based on the predicted event outcome compared against the event forecasting answer; and adjusting parameters of the decoder to increase the reward.

As another example, supplementing the method may comprise using a large language model to summarize the at least one training document. For example, encoding the at least one training document into the input vector may comprise: summarizing the at least one training document using a large language model; and encoding the at least one training document as summarized by the large language model into the input vector.

As another example, supplementing the method may comprise inputting multiple training documents to a large language model and prompting the large language model to select the at least one training document. The large language model used to summarize training documents may or may not be the same as the large language model used for ranking them.

As another example, supplementing the method may comprise segmenting questions with numeric answers from those with non-numeric answers. For example, the event forecasting question may be one of a plurality of event forecasting questions comprising at least part of the dataset; the obtaining the at least one training document, the encoding, the decoding, and the determining may be performed multiple times for the plurality of event forecasting questions, respectively; and the plurality of the event forecasting questions may all have numerical answers.

As another example of segmenting numerical from non-numerical answers, the event forecasting question may be one of a plurality of event forecasting questions comprising at least part of the dataset; the obtaining the at least one training document, the encoding, the decoding, and the determining may be performed multiple times for the plurality of event forecasting questions, respectively, and the plurality of the event forecasting questions may all have non-numerical answers. The plurality of the event forecasting questions may have at least one of: true or false, or multiple choice answers.

As another example of supplementing the method, questions with numerical answers may be binned. In this regard, the event forecasting question may be one of a plurality of event forecasting questions comprising at least part of the dataset; the obtaining the at least one training document, the encoding, the decoding, and the determining may be performed multiple times for the plurality of event forecasting questions, respectively; at least some of the plurality of the event forecasting questions may have numerical answers, and the event forecasting answers corresponding to the at least some of the plurality of the event forecasting questions that have numerical answers may correspond to binned groupings of the numerical answers.

The event forecasting answers corresponding to the at least some of the plurality of the event forecasting questions that have numerical answers may comprise midpoints of the binned groupings. At least some of the plurality of the event forecasting questions may have non-numerical answers.

As another example of supplementing the method, obtaining the at least one training document may comprise determining a retrieval score for each of the at least one training document, and the retrieval score of each of the at least one training document may satisfy a relevance metric threshold. The retrieval score may be determined with a suitably prompted large language model.

As another example of supplementing the method, obtaining the at least one training document may comprise determining a retrieval score for each of the at least one training document, and the input vector may comprise the retrieval score for each of the at least one training document prepended thereon.

According to another aspect, there is provided at least one artificial neural network trained according to the foregoing method.

According to another aspect, there is provided the use of at least one artificial neural network trained according to the foregoing method.

According to another aspect, there is provided a system for training at least one neural network to perform event prediction, the system comprising: at least one database having stored thereon a training dataset and at least one training article; at least one processor communicatively coupled to the at least one database and configured to perform the foregoing method.

According to another aspect, there is provided at least one non-transitory computer readable medium having stored thereon computer program code that is executable by at least one processor and that, when executed by the at least one processor, causes the at least one processor to perform the foregoing method.

According to another aspect, there is provided a method for performing event prediction, the method comprising: receiving an event prediction query; retrieving a plurality of documents comprising information pertaining to the event prediction query, each of the plurality of the documents classified on a relevance thereof to the event prediction query; generating an input vector with the event prediction query and the plurality of documents classified on relevance; processing the input vector with a neural network trained to determine an event prediction outcome corresponding to a response to the event prediction query; and generating the event prediction outcome of the event prediction query with the neural network. This method may be supplemented in any one or more ways as described below.

For example, supplementing the method may comprise processing the plurality of documents and the event prediction query with a first large language model to classify the plurality of documents based on relevance by generating, with the first large language model, a relevance score for each document of the plurality of documents to determining the relevance of each document. For example, the plurality of documents included in the input vector can comprise a subset of relevant documents selected from the plurality of documents based on the relevance score.

As another example of supplementing the method, the event prediction outcome can be a numerical response or a non-numerical response; and the non-numerical response can correspond to a multiple-choice answer or a true or false answer.

As another example of supplementing the method, the event prediction query can comprise: a text-based event prediction question; a plurality of possible event prediction outcomes; and an event prediction period corresponding to a start time and an end time defining a valid duration based on which the event prediction outcome is generated.

As another example of supplementing the method, the event prediction outcome can be discretized into to one of a plurality of binned groups of numerical values and the event prediction outcome can correspond to one of a plurality of midpoints of the plurality of binned groups.

As another example of supplementing the method, the relevance score can correspond to one of a plurality of integer bins representing the relevance of each document.

As another example of supplementing the method, the first large language model can process the plurality of documents and the event prediction query over a number of iterations to generate a plurality of relevance scores for each document and the relevance score of each document can be based on the plurality of relevance scores.

As another example, supplementing the method may comprise augmenting the relevance score with a recency score. For example, the recency score can be determined based on a time associated with each document.

As another example of supplementing the method, the subset of relevant documents can be selected based on a threshold relevance score.

As another example of supplementing the method, each of the plurality of documents can comprise a summary thereof generated with a second large language model.

As another example of supplementing the method, the neural network can be tuned using low-rank adaptation of large language models architecture.

As another example of supplementing the method, the neural network can be trained using a loss function comprising a decoder loss corresponding to accuracy of the event prediction outcome and an alignment loss corresponding to confidence in human temporal prediction.

As another example of supplementing the method, the plurality of documents can be news articles.

According to another aspect, there is provided a method of training at least one neural network for performing event prediction, the method comprising: obtaining a training dataset comprising: event prediction queries and a plurality of documents comprising information pertaining to the event prediction queries as inputs; and event prediction outcomes corresponding to responses to the event prediction queries as ground-truths; and training a neural network to determine the event prediction outcomes using the training dataset. For example, the plurality of documents can comprise documents classified on a relevance thereof to the event prediction query. This method may be supplemented in any one or more ways as described below.

As an example of supplementing the method, the plurality of documents and the event prediction query can be processed by a first large language model to classify the plurality of documents based on relevance by generating, with the first large language model, a relevance score for each document of the plurality of documents to determining the relevance of each document.

As another example of supplementing the method, the plurality of documents included in the training dataset can comprise a subset of relevant documents from the plurality of documents determined based on the relevance score.

As another example of supplementing the method, the subset of relevant documents can be determined based on a threshold relevance score.

As another example of supplementing the method, each of the plurality of documents can comprise a summary thereof generated with a second large language model.

As another example, supplementing the method may comprise sorting the training dataset based on the event prediction outcomes being numerical responses or non-numerical responses. For example, the training dataset can comprise the sorted training dataset; and the non-numerical responses can correspond to multiple-choice responses or true or false responses.

As another example, supplementing the method may comprise training the neural network to generate the event prediction outcomes as discretized numerical values corresponding to binned groups.

As another example of supplementing the method, the numerical values can be midpoints of the binned groups; and each of the event prediction outcomes can correspond to one of a plurality of possible event prediction outcomes.

As another example, supplementing the method may comprise training the neural network using a loss function comprising a decoder loss corresponding to accuracy of event prediction outcome and an alignment loss corresponding to confidence in human temporal prediction.

According to another aspect, there is provided a system for performing event prediction, the system comprising one or more processing units configured to perform a method comprising: receiving an event prediction query; retrieving a plurality of documents comprising information pertaining to the event prediction query, each of the plurality of the documents classified on a relevance thereof to the event prediction query; generating an input vector with the event prediction query and the plurality of documents classified on relevance; processing the input vector with a neural network trained to determine an event prediction outcome corresponding to a response to the event prediction query; and generating the event prediction outcome of the event prediction query with the neural network.

According to another aspect, there is provided a non-transitory computer-readable medium having computer readable instructions stored thereon, which, when executed by one or more processing units, causes the one or more processing units to perform a method for performing event prediction comprising: receiving an event prediction query; retrieving a plurality of documents comprising information pertaining to the event prediction query, each of the plurality of the documents classified on a relevance thereof to the event prediction query; generating an input vector with the event prediction query and the plurality of documents classified on relevance; processing the input vector with a neural network trained to determine an event prediction outcome corresponding to a response to the event prediction query; and generating the event prediction outcome of the event prediction query with the neural network.

This summary does not necessarily describe the entire scope of all aspects. Other aspects, features and advantages will be apparent to those of ordinary skill in the art upon review of the following description of specific embodiments.

### BRIEF DESCRIPTION OF THE FIGURES

In the accompanying drawings, which illustrate one or more example embodiments:

FIGS. 1A and 1B depict block diagrams of a system for training at least one neural network for event prediction, according example embodiments.

FIG. 2 depicts a LoRA (low-rank adaptation of large language models) architecture that may be used to fine-tune the system of FIGS. 1A and 1B, according to an example embodiment.

FIG. 3 highlights how a prompt to an encoder comprising part of the system of FIG. 1 may be customized in order to increase system performance, according to an example embodiment.

FIG. 4 depicts a reinforcement learning with human feedback (RLHF) framework, which may be used to improve performance of the system of FIGS. 1A and 1B, according to an example embodiment.

FIGS. 5A and 5B depicts block diagrams of training document retrieval pipelines comprising part of the system of FIGS. 1A and 1B, according to example embodiments.

FIG. 6 depicts an example computer system that may be used to implement the system of FIGS. 1A and 1B, according to an example embodiment.

FIG. 7 depicts example retrieval results of the pipeline of FIG. 5B in comparison to an alternative pipeline, according to an example embodiment.

FIG. 8 depicts a graph for visualizing recency scores, according to an example embodiment.

FIG. 9 depicts an example query and the corresponding retrieval results and response output by the system of FIGS. 1A and 1B, according to an example embodiment.

### DETAILED DESCRIPTION

The present disclosure is directed at enhancing the performance of machine learning models in the realm of real-life event forecasting. Two interrelated directions for improving the capabilities of existing models are described. The first direction focuses on innovative approaches to better understand news articles, which can enhance the contextual understanding necessary for accurate forecasting. The second direction involves methodologies aimed at more effectively incorporating human feedback and annotations, harnessing human forecasting expertise to further bolster machine forecasting abilities.

The initial focus of machine learning research in forecasting was predominantly on the prediction of time-series data, a relatively straightforward task when compared to the complexity of real-world events. However, as the demand for more accurate forecasts in diverse domains has grown, the need to integrate data from beyond the structured time-series modality has become apparent. One such critical modality is the continuous stream of news articles, often presented in lengthy textual formats. In the pursuit of predicting future events, the analysis and interpretation of news articles have become central to the endeavor.

Recent advancements in this field have demonstrated the potential of utilizing news articles to provide probabilistic estimates of real-world events. Nevertheless, it is evident that the field of event forecasting through machine learning is still in its early stages. Despite promising results, these methods have yet to reach the level of proficiency exhibited by human forecasters. A considerable gap exists between the theoretical potential and the practical feasibility of machine learning-based event forecasting.

In particular, questions that should be addressed in event prediction methodologies can include:
How can the selection of the most relevant news articles for event forecasting be improved?
How can the processing of selected news articles be optimized to extract information effectively?
How can the learning dynamics be refined to enable efficient model training and leverage the enriched information from relevant news articles?

The present disclosure relates to systems and methods for performing event predictions and can address these questions by incorporating one or more of the below aspects, which are described further herein:
1. Task-Aligned Retrieval Module that can align the information retrieval process with the central task of answering critical questions, thereby increasing the relevance of selected news articles.
2. Enhanced Neural Article Reader which can be enhanced through unsupervised distillation techniques, including summarization. This augmentation can enable the model to delve deeper into news articles, efficiently extracting pertinent insights.
3. Human-Aligned Loss Function that can consider human preferences and judgments to bridge the gap between machine learning models and human intuition.

More particularly, the present embodiments are directed at training a neural network to perform event prediction, and to subsequently use the trained network during testing/inference to perform predictions. Generally, the training method comprises:
1. Obtaining a training dataset. The training dataset comprises event forecasting question(s) (e.g. event prediction query) and corresponding event forecasting answer(s) (e.g. event prediction outcome) representative of human answer(s) to the event forecasting question, respectively. The Autocast dataset described in [2] may be used for the question(s) and answer(s), for example. The training dataset may also comprise information such as the category of question (e.g., science & technology; politics; economic); the type of answer expected (e.g., true/false; numerical; multiple choice); or whether the outcome to the question is known, which is referred to as whether the question has been “resolved”. The human answer to an event forecasting question may comprise, for example, the prediction made by a human forecaster when presented with the same or similar information as the at least one neural network.
2. Obtaining/retrieving at least one training document (e.g. document) pertinent to the event forecasting question. Example training documents comprise news articles, for example. News articles may come from the CommonCrawl news dataset [3].
3. Encode the neural network input into an input vector. Each of the event forecasting questions and corresponding training article(s) are encoded into an input vector for inputting to an encoder, which comprises part of the neural network being trained.
4. Decode the input vector into a predicted event outcome. The neural network being trained also comprises a decoder, which decodes the input vector into a predicted event outcome. This predicted event outcome can be compared against the actual event forecasting answer representative of a human answer, and the neural network may be trained (e.g., through backpropagation) accordingly. More particularly, in at least some embodiments the output is either 1) a binary answer to a question (e.g., “Will the economy grow, Yes or No? Answer: Yes”); 2) a multiple choice answer (e.g., “The economy will (a) enter a recession, (b) grow, or (c) stagnate. Answer: (c)”); or 3) a numeric answer resulting from a regression (e.g., “How much will the value for growth be for 2024, in percent? Answer: 2.4%”).

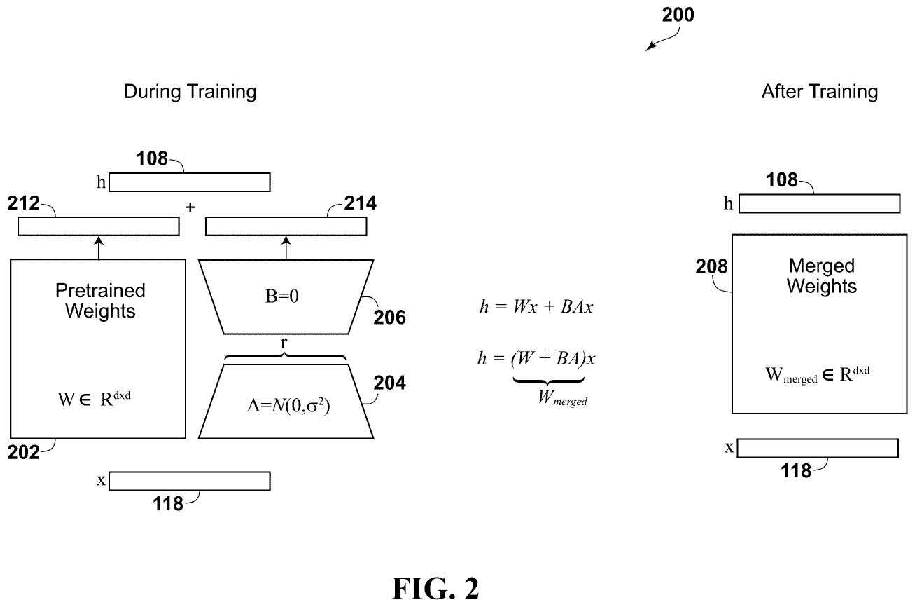

The method further comprises performing any one or more operations to enhance the training of the neural network:
1. applying LoRA to fine-tune neural network performance, as described in respect of FIG. 2;
2. using a large language model (LLM) to select training document(s);
3. using an LLM to summarize training document(s) prior to inputting them into the encoder;
4. separating event forecasting questions with numerical answers from event forecasting questions with non-numerical answers, such as multiple choice or true and false questions;
5. binning numerical answers together;
6. removing noisy data by taking into account relevance metrics or retrieval scores of the training document(s); or
7. prepending context, such as the relevance metrics or retrieval scores, to the input vector.

These are discussed in further detail below. The disclosed systems and methods are applicable for training and/or inference. That is, the disclosed systems and methods can be used to generate improved event prediction outcomes.

In particular, to generate an event prediction outcome, an event prediction query can be received. Documents such as new articles containing information related to the event prediction query can be retrieved or obtained, for example from a database (e.g. online database) or using a web crawler. The documents may be processed by a neural network such as a large language model to rank the documents based on relevance and to summarize the articles. The processed documents can be provided with the event prediction query to a second neural network as an input vector to generate an event prediction outcome corresponding to a response to the event prediction query. In some cases, the possible event prediction outcomes form part of the event prediction query. In some cases, the relevance of the documents may be determined based on recency (e.g. publication date) of the articles. In some cases, training datasets comprising numerical and non-numerical event prediction outcomes may be separated during training of the second neural network. In cases where the event prediction outcome corresponds to a numerical value, the event prediction outcome may be binned such that the second neural network is only required to generate a response belonging to one of the binned groups.

### Base Model

Two cases were explored in [2]: static and dynamic. The static model reads the top-K articles as input, and thereby has a fixed (and small-sized) context window for articles. The dynamic model reads the most relevant article for each point in time, which results in longer training times. The example embodiment that follows uses the static model as a base architecture, although other embodiments (not depicted) may use the dynamic model. The top-K articles can also be represented as top-N articles and may comprise a number of articles considered relevant or most relevant to the event prediction query. Further, the event prediction query itself can also be read by the static model.

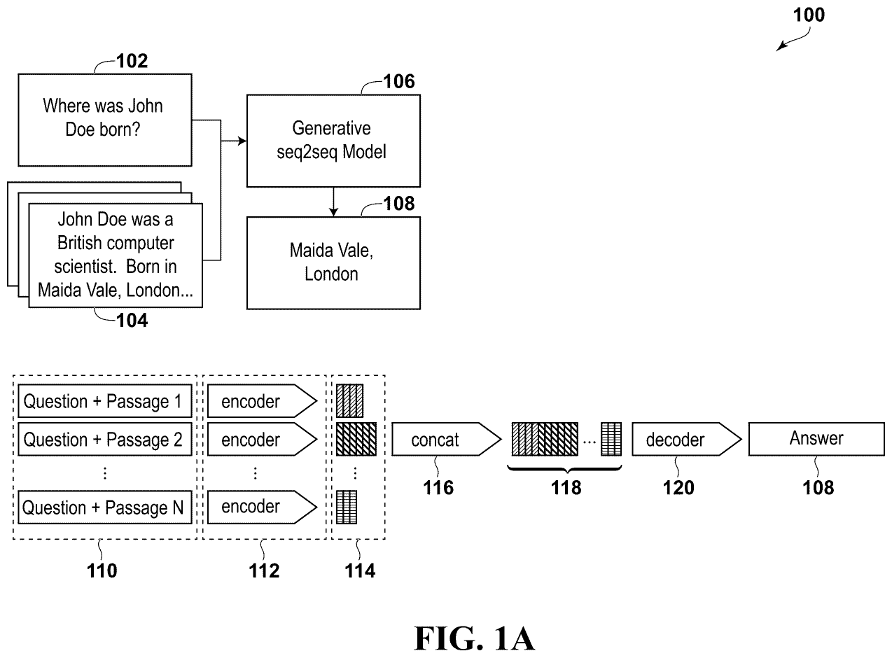

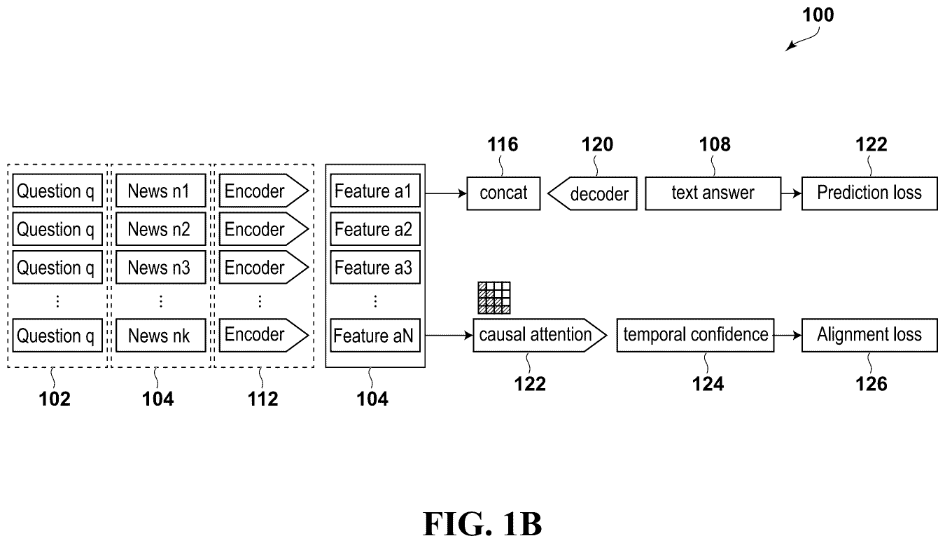

In FIG. 1A, there is shown a block diagram of a system 100 for training the neural network for event prediction, according to an example embodiment. The system 100 comprises a generative seq2seq neural network 106, which comprises an encoder 112 and decoder 120. The system 100 can also be used for performing event prediction, for example once the neural network 106 is trained. It should be noted that the descriptions herein are also applicable for the use of the system 100 in performing event prediction. An example event forecasting question 102 such as an event prediction query (“Where was Alan Turing born?”) and various documents such as training documents 104 (“Alan Turing was a British Computer scientist. Born in Maida Vale, London . . . ”) are shown as being input to the neural network 106. The event forecasting query 102 may be a set of event forecasting questions. The training dataset can comprise the query 102, documents 104, and the correct answer or response to the query 102.

Each query 102 can include the question text (e.g. text-based description of the questions), potential answer choices (e.g. True/False or a list of possible choices and the corresponding answers), start and end dates of the question (e.g. duration of query), and the type of question.

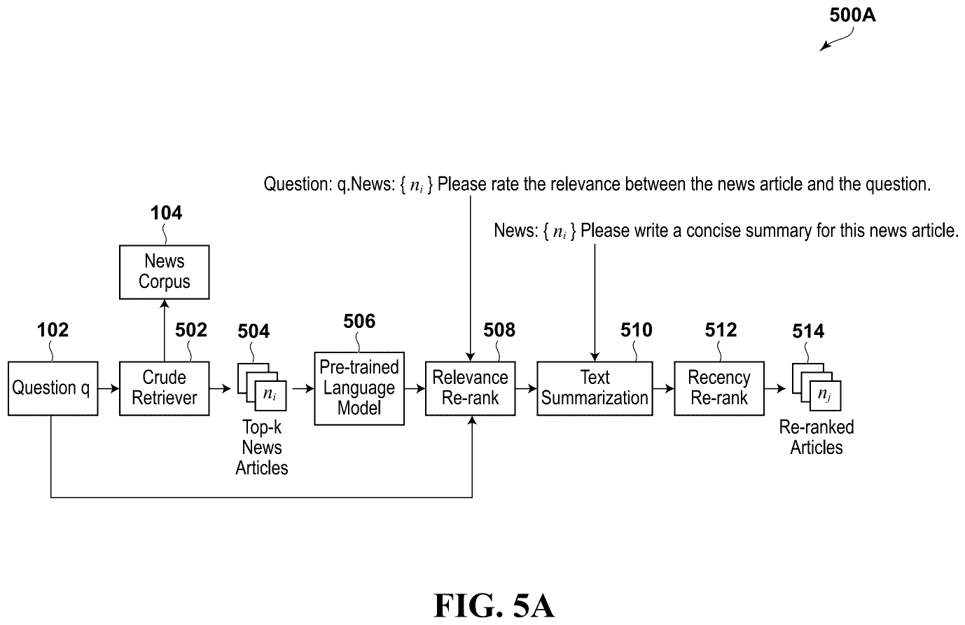

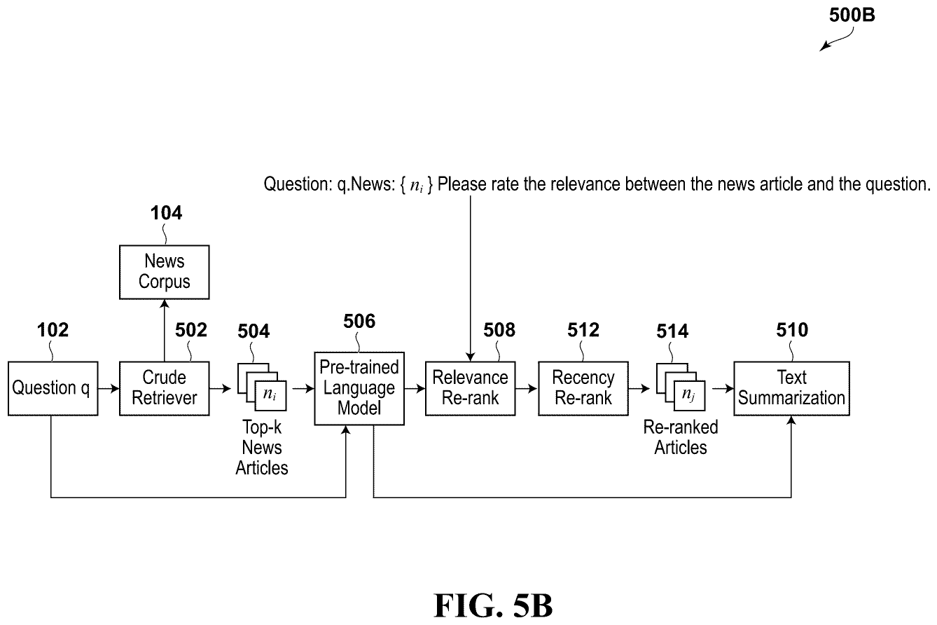

For a given query q from a question set comprising the event prediction query 102, a retriever module, such as pipelines 500A and 500B as described in FIGS. 5A and 5B, can select the documents 104, represented as N_{q}, such that they are pertinent news articles comprising information related to the event prediction query 102, for example from the news passages database represented by D={nᵢ_{₁}, nᵢ_{₂}, . . . , nᵢ_{_{M}}}. That is, the selected documents 104 may be a subset of a plurality of documents, which are retrieved by and then processed by the retriever module such as pipeline 500A or 500B. The selection criteria and the document processing are described further herein. The articles (e.g. documents 104) retrieved in relation to the event prediction query 102, q, can be represented as N_{q}={n₁, n₂, . . . , n_{K}}, where N_{q}∈D is the retrieved subset of news articles. Each news article nᵢ within the documents 104 (e.g. retrieval set N_{q}) can comprise a published date, title, text, and a relevance score relative to the event prediction query 102.

The event prediction query 102 and the documents 104 can be paired, represented by (q, N_{q}), and input into the neural network 106 to forecast an event outcome, o, being an event prediction outcome or answer 108. That is, the event prediction query 102 and the documents 104 can be encoded (e.g. concatenated) as an input vector 118. The event prediction outcome 108 may be defined as a discrete variable corresponding to one of the allowable or possible answers. For example, in the case of True/False questions, the outcome is represented as o∈{True, False}. In particular, event prediction outcomes 108 for event prediction queries 102 that are continuous-valued numerical questions can be discretized into groups or binned groups of numbers for better performance. An encoder 112 decoder 120 transformer of the neural network 106 can be used to produce answers (e.g. event prediction outcome 108) for the query 102 using a generative model p(o|q, N_{q}; Θ), where Θ represents the reader parameters. The objective can be to maximize the likelihood of generating the actual outcome o_{gt}: arg max_{Θ} p(o=o_{gt}|q,N_{q};Θ). The Fusion-in-Decoder (FiD) and T5 framework may be used.

In some embodiments, the training dataset comprises intermediate forecasting results from human experts for every query 102. These forecasts can be documented at various timestamps spanning the start and end of the question period/duration. The notation pₕ(o|q, t) can represent the probabilistic human prediction made at the timestamp t for the specific query 102, q. Specifically, pₕ(o=o_{gt}|q, t) denotes the accuracy of the human forecasters. As such, human feedback can be incorporated in the training of the neural network 106.

More particularly, FIG. 1A also schematically shows a variety of questions/queries and corresponding “passages”, corresponding to or taken from training documents 104 (e.g., such as through LLM article summarization, described in more detail below), that are used as input to the neural network 106 during training. As shown in FIG. 1A, each of the multiple questions 102 (e.g. queries) may be paired with one or more (training) documents 104, with the collective set of questions 102 and (training) documents 104 comprising input 110 to encoders 112. The encoders 112 comprise part of the neural network 106 and encode the input 110 and output a series of vectors 114, which are concatenated together by a concatenator 116 to form the input vector 118. The input vector 118 is input to a decoder 120, also comprising part of the neural network 106, to generate the answer 108 (“Maida Vale, London”). In some embodiments, the encoders 112 and/or the concatenator 116 may be separate entities and do not form a part of the neural network 106. As such, the neural network 106 can be configured to only accept inputs (input 114 or input vector 118) to generate the answer or event prediction outcome 108.

FIG. 1B shows a block diagram of another embodiment of the system 100. As with FIG. 1A, the system 100 of FIG. 1B comprises the event prediction queries 102 prepended to (training) documents 104 in the form of news articles. An example method to select the news articles is depicted and discussed in respect of FIGS. 5A and 5B, below. The event prediction queries 102 and documents 104 are then encoded using the encoders 112 to result in vectors 114, which in FIG. 1B are depicted as feature vectors. As in FIG. 1A, they are concatenated together using the concatenator 116, subsequently decoded using the decoder 120 to result in the answers 108 to the event prediction queries 102. A prediction loss 122 or decoder loss (as described further herein) may also be calculated for training purposes.

In contrast to FIG. 1A, the system 100 of FIG. 1B also feeds the vectors 114 into a causal attention mechanism 122 to determine temporal confidence 124, from which an alignment loss 126 may be determined for training purposes, as described further herein.

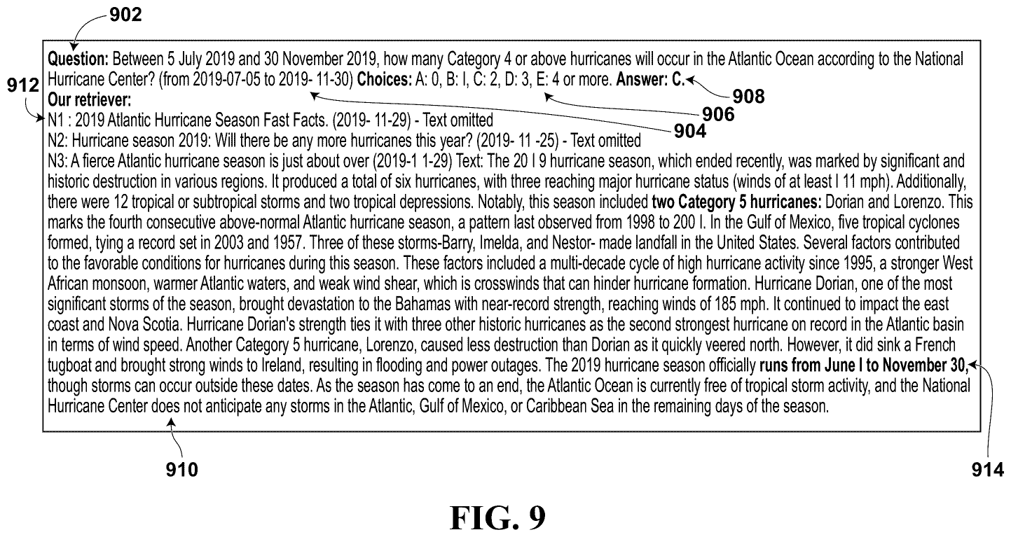

A further example of a query that can be included in the input vector 118 is shown in FIG. 9. Specifically, an event prediction query 902 includes the question itself in plain text format as well as the start and end date 904 of the event prediction query 902. The event prediction query 902 also comprises a list of potential event prediction outcomes 906, depicted as multiple-choice options. The output of the system 100 is the event prediction outcome 908.

### Enhancements

A variety of enhancements can be applied to the system 100 of FIGS. 1A and 1B.

For example, LoRA [1] may be applied to fine tune the system 100, resulting in faster training times with negligible drop in performance. Details are shown in FIG. 2, while experimental validation is described below. Experimentally, it was found that applying LoRA significantly shortens training times. For example, even with a relatively small model of 0.8 billion parameters, training without LoRA takes multiple days, while with LoRA training was sped up by a factor of at least 2 to 3.

FIG. 2 depicts a LoRA (low-rank adaptation of large language models) architecture 200 that may be used to fine-tune the system of FIGS. 1A and 1B. In FIG. 2, a pretrained weights matrix 202 represents the weights of the neural network 106 prior to applying LoRA, and matrices A and B 204, 206 represent fine tuning done to the pre-trained weights. As shown in FIG. 2, the answer 108 output by the fine-tuned system 100 comprises h=Wx+BAx, where h in the context of the system 100 represents the answer or event prediction outcome 108; x represents the input vector 118, W is the pretrained weights matrix 202, and matrices A and B 204, 206 are used to fine tune the pretrained weights matrix 202. The answer 108 is the sum of intermediate outputs 212, 214, wherein one of the intermediate outputs 212 is determined using the pretrained weights matrix 202 and the other of the intermediate outputs 214 is determined using matrices A and B.

At the start of fine tuning, matrix B is set to zero and consequently h=Wx. During training, the pretrained weights matrix 202 is frozen and the weights represented by matrices A and B are adjusted such that after training h=(W+BA)x, where W+BA is a merged weights matrix 208. Fine tuning is done in accordance with [1].

Enhancements to the system 100 of FIGS. 1A and 1B may additionally or alternatively be done with LLMs (e.g. neural networks). For example, the (training) documents 104 in the form of articles or otherwise may be summarized using an LLM prior to being transformed into part of the input vector 118. An LLM such as ChatGPT™ and LLAMA2™ may be used to specifically summarize documents 104 that are relevant to the event prediction query 102 in order to reduce computation time. In particular, summarization can extract relevant information to avoid indiscriminately processing all available data. As such, by reducing information volume and limiting documents 104 to relevant information, computational time for the neural network 106 for decoding the input vector 118 can be reduced, and the performance in deriving the correct event prediction outcome 108 can be improved. When news articles are to be input as (training) documents 104, an appropriate prompt such as “Please summarize the news article below and be concise and coherent,” may be used to prompt the LLM, following which the article is also input to the LLM. The LLM outputs the summary for use in generating the input vector 118. Experimental results below describe LLM article summation in more detail. While summarization is described as being performed by LLMs or neural networks, other summarization methods are acceptable as well.

LLM prompts may also be used to enhance document 104 selection. For example, the documents 104 in the form of articles or otherwise may be selected using an LLM prior to being transformed into part of the input vector 118. The documents 104 selected via the LLM may be subsequently summarized using the same or a different LLM as described above, although other selection methods are possible as well. An LLM such as ChatGPT™ and LLAMA2™ may be used to specifically select documents 104 that are relevant to the event prediction query 102. In some embodiments, the documents 104 may be additionally or alternatively processed (e.g. by the LLM) to determine a relevancy thereof to the event prediction query 102, as described further herein. The relevancy may be represented using a relevance store and may be used: to rank the documents 104, to select the documents 104 to be included in the input vector 118, and/or included as a part of the input vector 118. When news articles are to be input as (training) documents 104, an appropriate prompt such as “Please select from the news articles below the most relevant articles relevant to [event prediction query 102],” may be used to prompt the LLM, following which a series of articles is also input to the LLM. The LLM outputs the selection of articles for use in generating the input vector 118. Experimental results below describe LLM article selection in more detail.

FIGS. 5A and 5B depict block diagrams of two example training document retrieval pipelines 500A and 500B comprising part of the system of FIGS. 1A and 1B, according to example embodiments. The pipelines 500A, 500B depict how one or more LLMs or neural networks may be used for selecting or summarizing the documents 104, as described above. In particular, FIGS. 5A and 5B depict general frameworks of separate embodiments of a retriever or retriever module acquiring and processing documents. For example, pipelines 500A, 500B can retreive, rank, and select articles which can be used as input for the neural network 106 in generating event prediction outcomes 108.

The pipeline 500A begins with a question 102 and the related (training) documents 104, which in FIG. 5A are news articles. The news articles and the question 102 are input to a crude retriever 502, such as the FiD model used in [1]. This results in an initial ranking of the top-k (or top-N) news articles 504, where k (or N) is any positive integer. These top-k news articles 504 (Nq, as described above) are input into a pre-trained relevance LLM or neural network at block 506, such as ChatGPT™, which the question 102 is also input to at block 508. With the top-k news articles 504 and the question 102, the relevance LLM is prompted to rate the relevance of each of the top-k news articles based on the content of the articles 504 and the question 102, either relative to each other or using an objective metric such as a numeric score (e.g. relevance score). In the example of FIG. 5A, the relevance LLM at block 506 is prompted using, “Please rate the relevance between the news article and the question.”

In some embodiments, at block 506, the documents 104 may be ranked based on a relevance score, represented by sᵣ(nᵢ, q), ∀nᵢ∈N_{q}, obtained in a zero-shot manner. As such, it is possible to forgo the need for task-specific training data, leveraging a pre-trained LLM (e.g. the relevance LLM) for ease of implementation. In some embodiments, binning-based relevance score estimation can be performed for sᵣ(nᵢ, q). For example, instead of estimating the continuous-valued relevance score directly, it is possible to assess a discrete relevance label g that corresponds to up to G bins, evenly distributed in the range of 0 to 1. As such, the LLM is only required to determine which one of a discrete binned value the relevance score belongs to. The LLM assessment output g can represent an estimated relevance of the article to the query, which is quantified on a scale from 1 to G, represented by Equation 1 below:

$${s}_{r} ( {𝓃}_{𝒾} , q ) \approx \frac{𝔼 [ g ]}{G - 1} , g \sim p ( g \vert {𝓃}_{𝒾} , q ; Ψ ) \qquad ( Equation 1 )$$

where, Ψ denotes the parameters of the pre-trained LLM (e.g. relevance LLM), and g∈{0, 1, . . . ,G-1} represents the discrete relevance metric. In particular, it is possible to append straightforward language to the question and article tokens, such as: “Please rate the relevance between the news article and the question on a scale of 0 to 4, with 4 being the most relevant” as a prompt for the LLM. In the provided example, G=5. That is, the relevance LLM may be prompted to provide an integer value (e.g. binned result) that represents a relevance score of the news article to the query. The relevance score can be used to rank the articles 504.

In some embodiments, it is possible to perform article ranking using relevance LLM multiple times (denoted by 1), to estimate [symbol] [g]=1/l Σᵢ₌₁^{l} gᵢ to evaluate sᵣ(nᵢ, q). That is, the LLM may be prompted to provide the relevance score for the articles 504 multiple times to generate a plurality of relevance scores for each document 104. The relevance score may be updated (e.g. by generating an updated relevance score) for each article 504 using the plurality of relevance scores, for example an average thereof.

The output of the relevance LLM at block 506 is the top-k news articles 504, re-ranked by relevance as determined by the prompted relevance LLM 506. The re-ranked articles 504 are then summarized using a summarization LLM at block 510, which may be the same as or different from the relevance LLM. The summarization LLM is also suitably prompted to summarize each of the re-ranked articles 504. In the example of FIG. 5A, the prompt input to the relevance LLM for each of the re-ranked articles 504 is “Please write a concise summary for this news article.”

In particular, news articles often encompass lengthy segments, including interviews and analyses, which might not directly provide factual insights. Extracting significant information from these potentially relevant sections can pose a challenge. Accordingly, providing article summary rather than raw articles can provide improved results in generating event preduction outcomes 108.

Following article summarization, the summaries are re-ranked again by recency at block 512, for example with more recent articles being ranked higher than older articles. The re-ranked articles 514 output from block 512 are then provided to the neural network 106.

Specifically, timeliness of context passages can be pivotal in determining their usefulness. For instance, when addressing forecasting queries about natural disasters, news reports closer to the question ending date often hold more value compared to early-stage reports. The ever-changing dynamics of the real world profoundly impact the favored responses to forecasting queries. Thus, the content-based news-question relevance (e.g. as described above with reference to block 508) can be improved by leveraging human-feedback statistics to gauge temporal truthfulness and prioritize more recent news. As such, it can be valuable to generate a recency score represented by a numerical value for the news articles 504 based on the date (e.g. publish time) of the new article to accommodate for the assumption that more recent articles are more accurate (e.g. relevant). The recency score can be used to re-rank the articles by adjusting the relevance (e.g. the relevance score) of the articles to account for the described temporal effect.

For example, articles 504, N_{q}, may be ordered chronologically, such as n_{τ}_{₁}, n_{τ}_{₂}, . . . , n_{τ}_{_{K}}, where the publication date for news n_{τ}_{ᵢ} is tᵢ and t₁≤t₂, . . . ,≤t_{K}, with t_{K} being the most recent date. In some embodiments, it is postulated that a recency score sᵣ(nᵢ, q) for news dated t_{K} correlates with the temporal performance enhancement observed in human forecasters, represented by Equation 2 below:

$${s}_{t} ( {𝓃}_{{τ}_{K}} , q ) \approx \frac{{p}_{h} ( o = {o}_{gt} \vert q , {t}_{K} ) - {p}_{h} ( o = {o}_{gt} \vert q , {t}_{K - 1} )}{{t}_{K} - {t}_{K - 1}} \qquad ( Equation 2 )$$

In particular, forecasters can provide responses at time t_{K} using information available up to that point, encompassing the articles n_{τ}≤K. That is, more information is available at the latter time and accordingly, the articles of a later date can be more accurate. It is possible to assess sₜ(n_{τK}, q) by examining the variation in human forecaster accuracy, averaged over the time gaps between two successive articles. To derive temporal dynamics that are agnostic to specific query-news pairings, one can calculate the expectation across the empirical question distribution q∈Q and its top-K news articles N_{q} distribution, represented by Equation 3 below:

$${s}_{t} ( t ) \approx {𝔼}_{q ∈ Q} {𝔼}_{𝓃 t ∈ Nq} [ {s}_{t} ( {𝓃}_{t} , q ) ] \qquad ( Equation 3 )$$

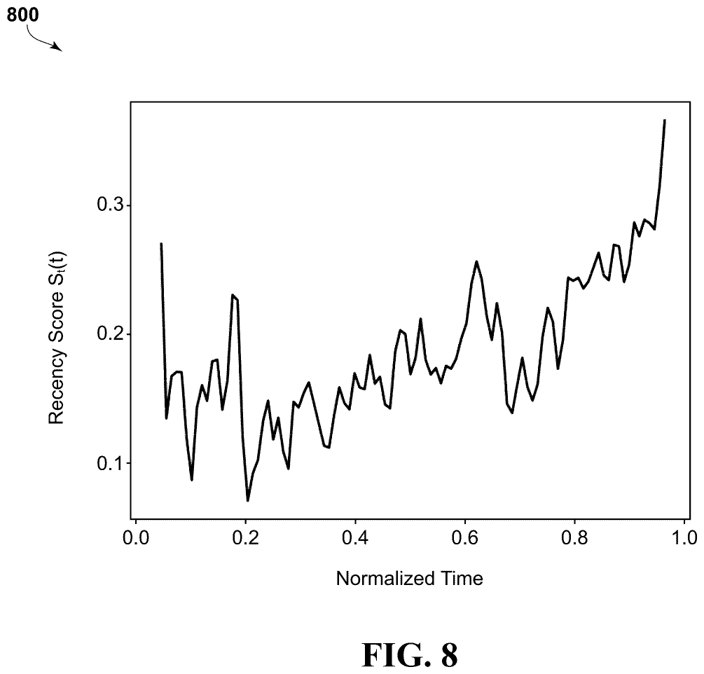

In some embodiments, the time (e.g. t) may be normalized relative to the question start and expiry date rather than using absolute time to accommodate queries with extended duration (e.g. over multiple years). A visualization of the recency score sₜ(t) according to an example embodiment is shown in FIG. 8, which depicts a graph 800 showing the recency score over a period of normalized time where 0 and 1 respectively represent the start and end date. As depicted, when the query expiry date nears, human forecaster accuracy typically increases more rapidly. As such, the recency score can be a statistical measure capturing general patterns across a training dataset.

Further, a final relevance score s (e.g. updated relevance score) based on the relevance score (described in 508) and the recency score (described in block 512) can be determined for each article, for example by using Equation 4 below.

$$s ( {𝓃}_{𝒾} , q ) = {s}_{r} ( {𝓃}_{𝒾} , q ) \cdot {s}_{t} ( {t}_{{𝓃}_{𝒾}} ) \qquad ( Equation 4 )$$

where tₙ_{ᵢ} denotes the normalized time of news, sᵣ corresponds to the the relevance of the content represented by the content relevance score, and sₜ corresponds to the recency of the content represented by the recency score.

In some embodiments, any one or more of the above described scores may be included in the input vector 118 for decoding by the neural network 106. Any one or more of the above described scores can also be used to rank or order the articles included in the input vector 118 in an order of relevance determined by the scores. For example, after computing the final relevance score s (e.g. for each q∈Q and nᵢ∈N_{q}), the articles N_{q} can be re-ordered. In some embodiments, only a number of most relevant articles (e.g. top-K or top-N articles) may be selected for decoding by the neural network 106, which can be determined via the relevancy-based ordering. Any one or more of the above-described scores may also be used as threshold value(s) for article selections. For example, articles having a value below a certain set threshold may not be included in the input vector 118.

While FIG. 5A shows the training documents 104 being ranked by the relevance LLM 506, summarized by the summarization LLM 510, and then again ranked by date, in at least some other embodiments all three operations do not need to be performed. For example, any one or any two of the relevance ranking, summarization, and temporal ranking may be performed in at least some other embodiments. Further, the above described operations may be performed in different orders. For example, in the embodiment pipeline 500B as depicted in FIG. 5B, comprising substantially the same elements and operations, text summarization at block 510 is performed after blocks 508 and 512 corresponding to the ranking of the articles by relevancy and recency. Further, it should be noted that other orders of operations are possible as well.

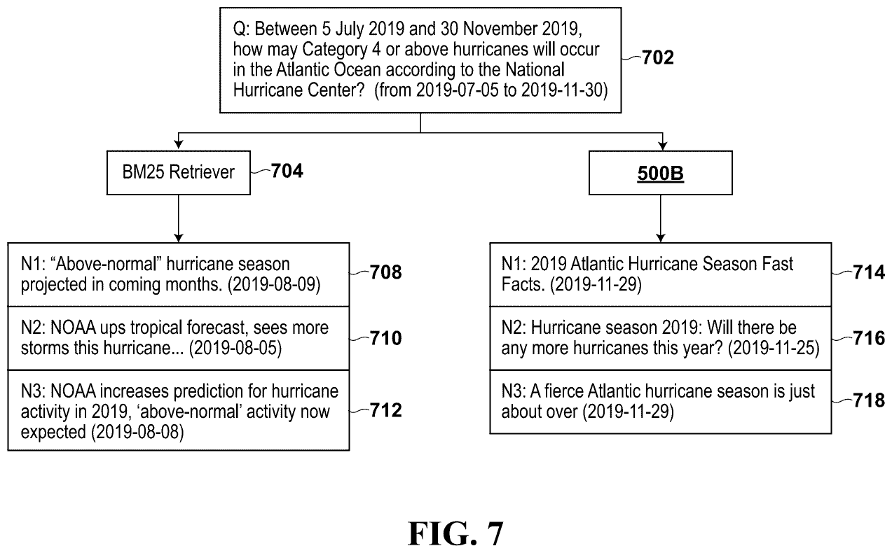

FIG. 7 depicts a diagram comparing the articles selected by an example embodiment of pipeline 500B and an alternative pipeline 704 (BM25 retriever). As shown in FIG. 7, for a given query 702 corresponding to an event prediction question or query, the alternative pipeline 704 returned articles 708, 710, 712, ranked in terms of relevance respectively as N1, N2, and N3, which represents relevancy from most relevant to least relevant. The pipeline 500B returned articles 714, 716, and 718, ranked in terms of relevance as respectively represented by N1, N2, and N3. Articles 714, 716, and 718 are shown to be different from articles 708, 710, 712. As shown in FIG. 7, the given query 702 has an end date (expiry date) of 2019 Nov. 30. The articles 714, 716, and 718 are determined by the pipeline 500B to be more relevant to the given query 702 as the respective dates (e.g. publish dates) of the 714, 716, and 718 are 2019 Nov. 29, 2019 Nov. 25, and 2019 Nov. 29. The alternative pipeline 704 only identified articles lexically. As such, recency is not a factor of relevance for alternative pipeline 704, and articles 708, 710, 712 have publish dates that are further from the expiry date of the given query 702. As discussed above, the questions 102 may also be segmented into those with numerical answers/outcomes and those with non-numerical answers/outcomes 108, such as true and false or multiple choice questions. Rather than prompting the neural network 106 for direct answers, the answers 108 may be grouped into various bins, such as quantiles.

Specifically, to improve the performance of the neural network 106 and, in particular, the decoder 120 in generating numerical answers, which are generally continuous and non-discrete, the numerical answers can be discretized into binned groups of numerical values. For example, a continuous-valued numerical outcome can be represented as oₙᵤₘ∈ [symbol] , which is categorized into R groups or bins:

$${o}_{num}^{′} ← ⌈ \frac{{o}_{num}}{{o}_{num}^{max} - {o}_{num}^{min} / R} ⌉ ∈ \{ 1 , … , R \} ,$$

where oₙᵤₘ^{max} and oₙᵤₘ^{min} represent the maximum and minimum numerical answer value, respectively. Discrete bins o′ₙᵤₘ can serve as proxy training targets. To revert to the numerical value space, the median value or midpoint of each bin can be used, represented by:

$${o}_{num} ← {o}_{num}^{′} \frac{( {o}_{num}^{max} - {o}_{num}^{min} )}{2 R} .$$

In some embodiments, the range of numerical values can be generalized to [0, 1] where to oₙᵤₘ^{max} is 1 and oₙᵤₘ^{max} is 0, to simplify the discretization process. That is, the neural network 106 can be trained to select the most probable bin in which the numerical value is likely to fall, and to retrieve the quantitative value, the midpoint numerical value of each bin can be used, although in alternative embodiments a different value may be used such as another number contained within the range spanned by the bin.

Noise reduction and contextual text prepending may also be used to improve neural network 106 performance. Noise reduction may be done by ablating those training documents 104 that score below an ablation threshold in terms of relevance to the questions 102 prior to training the system 100. For noise reduction, the documents 104 may be ranked according to a suitable method, such as the BM25 method. This results in a relevance metric or retrieval score for each of the documents 104. Selecting only those documents 104 whose relevance metric satisfies a relevance metric threshold helps to ensure that the neural network 106 makes forecasting decisions using the most relevant information, thereby enhancing performance. For example, during training in the context of a question 102 such as “What will growth in Canada be for 2024?” where the answer 108 is “2.4%”, without noise reduction the training documents 104 may comprise ten articles about economic growth and three articles about tennis. With noise reduction as described herein, the three articles about tennis have a retrieval score below the ablation threshold, meaning they are not even used for training and the neural network 106 is trained using only the more relevant documents 104.

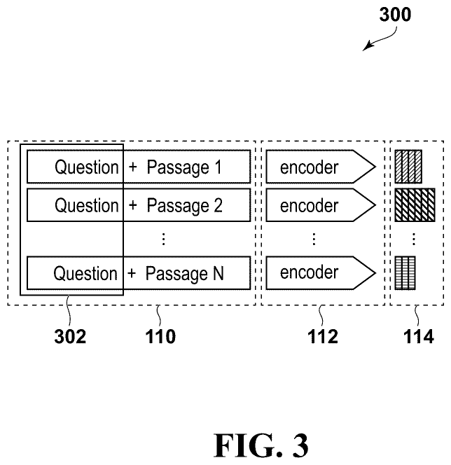

Also, taking into account the relevance metrics or retrieval scores of a document 104, performance improvements can be realized when these metrics/scores are prepended to the input vector 114. This is depicted in FIG. 3, which shows the input 110, encoders 112, and vectors 114 in detail. The metrics/scores may be prepended to the input 110 and more particularly to the questions 102, as represented by box 302. The metrics/scores may alternatively be appended to the input 110 or otherwise incorporated into the input vector 118.

In some embodiments, to generate the input vector 118, the question 102, q (e.g. token thereof), and the documents/news articles 104 (e.g. tokens therefrom) sourced from the top-N retrieval results, N_{q}, can be combined (e.g. appended/prepended together). This can produce question-news pair which can undergo the prepending process independently, denoted by xᵢ=prepend(q, nᵢ). Temporal data comprising the start and end dates of queries and the publication dates of news articles can also be included in the input vector 118.

In particular, the question 102, q, and its top-N retrieved articles, N_{q}, can be concatenated using the concatenator 116 for encoding the input vector 118. For example, the concatenation can be represented by: q′=q [SEP] date(q) [SEP] choices(q); n′ᵢ=title(nᵢ) [SEP] date(nᵢ) [SEP] nᵢ, and xᵢ=[CLS] q′ [SEP] n′ᵢ[SEP], where [CLS] is the beginning of the sequence, and [SEP] is the separator token. That is, the question can be augmented with its starting and ending dates, along with its allowable choices (e.g. possible event prediction outcomes) to provide a comprehensive description of both the query and the context. Further, the documents 104 (e.g. news articles or summaries thereof) can be prefixed with its title and date.

The encoder 112 (e.g. T5 encoder, fₑ) can be used to process the concatenated tokens to generate a textual representation of the sequence, represented by: ∀i∈[N], zᵢ=fₑ(xᵢ; Θ); Xₑ=concat (z₁,z₂, . . . , z_{N}). The decoder 120 (e.g. T5 decoder, f_{d}) can derive the answer (e.g. generate the event prediction outcome 108) for the event prediction query 102, for example by employing both crossattention and causal self-attention mechanisms. These mechanisms account for the tokens in Xₑ and the tokens generated previously, respectively. The concatenating representations from diverse documents can provide the decoder 120 of the neural network 106 with a holistic view of the information. The answer generation process can be modeled by an autoregressive decoder p(o|q, N_{q}; Θ).

Referring again to FIG. 9, the articles retrieved and processed by the pipeline 500B shown by way of an example embodiment are depicted. Each of the articles 910 comprise a summary of the content of the article, as generated by the summarization LLM at block 510. The articles 910 can be ordered according to a relevance rank 912 (e.g. N1, N2, . . . , where lower number indicates higher relevancy), based on the ranking by relevance LLM at block 506 and the recency re-ranking at block 512. Key information 914 is highlighted, which can be inferenced by the neural network 106 to generate the predicted event outcome 908.

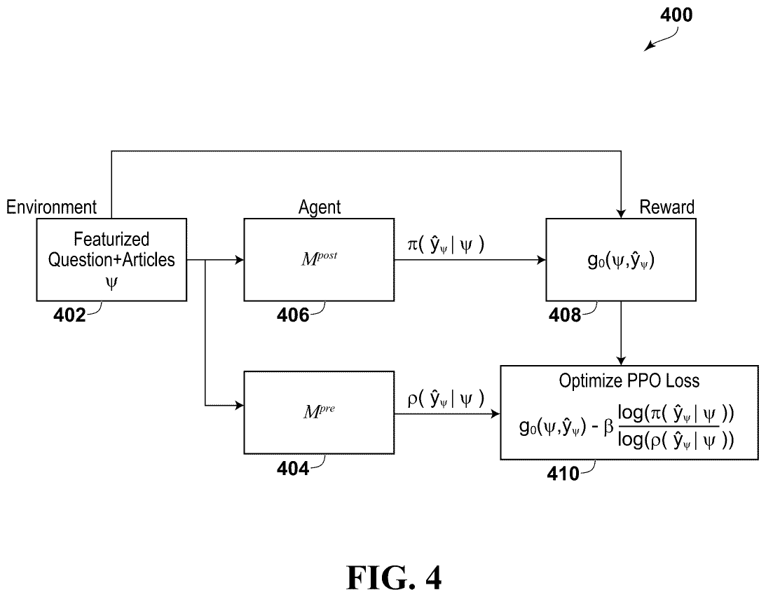

Reinforcement learning may also be used to fine tune neural network 106 performance. FIG. 4 depicts a reinforcement learning with human feedback (RLHF) framework 400 that may be applied for this purpose, according to an example embodiment. This fine tuning is done in two stages:
1. Learning the underlying reward function that the human is optimizing.
2. Improve the (pre-trained) neural network 106 by maximizing the learned reward model using a policy optimization method. The reward model is applied using a non-feedback agent 404 and a feedback agent 406.

With reference to FIG. 4,
Qₜ=q represents a question 102 at time t.
t_{q}^{e} denotes the expiry time of the question q.
[symbol] ={A₁^{ϕ}^{₁}, . . . , Aₖ⁹⁹^{ₖ}} denotes the set of training documents 104 in the form of news articles with k elements. The time when article Aₖ is published is given by ϕₖ where ϕₖ<t_{q}^{e}.
ψ: represents the feature vector where ψ=f(q, [symbol] ) where f is a feature function.

The reward model trained using the FID static dataset [1], denoted as [symbol] ^{pre}, does not incorporate human feedback during the training phase. For a given input feature set ψ, the predicted answer 108 provided by model [symbol] ^{pre} is represented as ŷ_{ψ}, while the corresponding human-provided forecast is denoted as y_{ψ}. The aim is to learn a parameterized reward function g_{θ}, using the following input and target values:
Features: [ψ, ŷ_{ψ}]
Targets(Reward): 1−|y_{ψ}−ŷ_{ψ}|

Regression is employed, utilizing a feedforward neural network to model g_{θ}.

[symbol] ^{pre} is fine tuned using human feedback. This frames the fine tuning as a reinforcement learning (RL) problem. The RL framework involves interaction between an agent and an environment 402:
1. Environment 402. The environment 402 comprises a question dataset of event forecasting questions 102 and news articles representative of training documents 104. At time t, the state is represented as Sₜ=ψ.
2. Agent 404. The agent 404 in this context is the non-feedback agent 404 corresponding to the pre-trained model [symbol] ^{pre} with weights w. The agent's 404 policy is denoted as π(ŷ_{ψ}|ψ), where the agent 404 observes ψ and generates a prediction ŷ_{ψ}. The agent then receives a reward according to g_{θ}(ψ, ŷ_{ψ}).

As there are no environment dynamics (i.e., the next state Sₜ₊₁=ψ′ does not depend on Sₜ=ψ and ŷ_{ψ}), this is a contextual bandit problem where the environment 402 resets after a single step.

FIG. 4 depicts the RLHF architecture 400. As discussed above, the environment 402 comprises the questions 102 and corresponding training documents 104 in the form of news articles. The non-feedback agent 404 is [symbol] ^{pre} as described above, while [symbol] ^{post} is the feedback agent 406, which is [symbol] ^{pre} with its weights updated in response to the human feedback. Initially, at iteration 0, [symbol] ^{post}= [symbol] ^{pre}. Policy is improved iteratively to update the model's weights; i.e., to determine [symbol] ^{post} from [symbol] ^{pre}. In successive iterations, the weights of the model [symbol] ^{post} are refined. More particularly, the reward 408 is determined as g_{θ}(ψ, ŷ_{ψ}) as described above, and a proximal policy optimization (PPO) loss 410 is determined as

$$L = {g}_{θ} ( ψ , {\hat{y}}_{ψ} ) - β \frac{log ( π ( {\hat{y}}_{ψ} \vert ψ ) )}{log ( ρ ( {\hat{y}}_{ψ} \vert ψ ) )} .$$

Iteratively minimizing this loss through backpropagation results in iterative improvements in the weights of [symbol] ^{post}, which results in improved performance of the neural network 106.

As described above, training datasets such as the Autocast dataset can include intermediate probabilistic responses from human forecasters, denoted by pₕ(o|q, t), gathered over various dates. Utilizing these labels, the encoder text representations {zᵢ}ᵢ can be harmonized (e.g. adjusted to accommodate) the beliefs held by human forecasters, represented by the intermediate probabilistic responses. The concatenated question-news token sequences {xᵢ}ᵢ can be arranged chronologically, following tₓᵢ≤tₓᵢ₊₁ . . . . A self-attention mechanism integrated with a causal mask can be used in some embodiments, which founded upon the text features {zᵢ}ᵢ. This layer can infer the contextual confidence up to time instant t: p(uₜ|z<ᵣ, Φ). Here, uₜ∈[0, 1] represents the confidence, while Φ represents the self-attention layer parameters. By aligning the inferred confidence with the accuracy of the human forecaster (e.g. pₕ(O_{gt}|q, t)). Accordingly, the regularizing of the learning of the text representation can be achieved. As such, the training of the neural network 106 may include the use of a loss function that aims to minimize decoder loss (e.g. prediction loss 122) corresponding to accuracy of the event prediction outcome and alignment loss 126 corresponding to confidence in human temporal prediction. The loss function can be represented as Equation 5 below:

$$L = - log p ( o \vert q , {N}_{q} ; Θ ) - λ \frac{1}{N} {\sum }_{t = 1}^{N} {𝒟}_{KL} ( {p}_{h} ( {o}_{gt} \vert q , t ) ‖ p ( {𝓊}_{t} \vert z {\leq }_{t} ; Φ ) ) \qquad ( Equation 5 )$$

where λ is a weighting coefficient and cross-entropy loss can be used for both terms in implementation, and where the first term corresponds to the decoder loss and the second term corresponds to the alignment loss.

### EXPERIMENTS

The system's 100 performance is evaluated by way of an example embodiment by employing the Autocast dataset [2] as a benchmark (these results are referred to as the “(paper)” results in the subsequent tables). Autocast represents a future event forecasting dataset that encompasses a substantial number of annotated questions spanning a diverse array of domains, including economics, politics, and technology. This dataset comprises three distinct question types: 1) True/False (T/F); 2) Multiple-choice (MCQ); and 3) numerical prediction. To complement the questions in the Autocast dataset, the Common Crawl corpus [3] is used to source news articles with semantic relevance. This extensive database comprises news articles from 2016 to 2022. The methods outlined in the Autocast paper [2] are applied for lexical analysis and the generation of ranked retrieval results for each question. The example embodiment retrieves 50 articles using BM25 with N=10 and λ=0.1.

The results show that the disclosed system can significantly enhance baseline models across various metrics, resulting in a noteworthy 48% boost in accuracy for multiple-choice questions (MCQ), an appreciable 8% improvement for true/false (TF) questions, and a substantial 19% enhancement for numerical predictions. These results can emphasize the progress made in advancing event forecasting through machine learning.

To assess the system's 100 proficiency in handling T/F and MCQ questions, accuracy is employed as the primary evaluation metric. For numerical prediction questions, the system's 100 performance is evaluated by computing the absolute error associated with its predictions.

In respect of LoRA, experiments demonstrate that LoRA enables reproduction of the outcomes presented in [2] while maintaining performance at a virtually indistinguishable level.

TABLE 1
LoRA Impact on FiD Static Model Performance and Training Efficiency

| | Training | Trainable | | | |
|---|---|---|---|---|---|
| Model | Time | Parameters | T/F↑ | MCQ↑ | Num↓ |
| FiD Static | — | 0.2 B | 62.0 | 29.6 | 24.5 |
| (paper) | | | | | |
| FiD Static | — | 0.8 B | 64.1 | 32.4 | 21.8 |
| (paper) | | | | | |
| FiD Static | — | 2.8 B | 65.4 | 35.8 | 19.9 |
| (paper) | | | | | |
| FiD Static | ~1 day | ~3M (0.2 B) | 62.1 | 29.3 | 22.2 |
| (LoRA) | | | | | |
| FiD Static | ~2 days | ~10M (0.8 B) | 64.5 | 32.9 | 20.4 |
| (LoRA) | | | | | |

In respect of LLM-based article selection, LLM-based article selection provides the flexibility to choose articles using either the initial retrieval methodology in [2] or leverage LLMs as an article relevance guide. The initial retrieval methodology comprised applying a ranked retrieval methodology, such as BM25, to estimate relevance. The outcomes are illustrated in Table 2.

TABLE 2
Effects of Different News Article Sources on Model Performance

| | Training | Testing | Model | | | |
|---|---|---|---|---|---|---|
| Model | Data | Data | Size | T/F↑ | MCQ↑ | Num↓ |
| FiD Static | Raw text | Raw text | 0.2 B | 62.0 | 29.6 | 24.5 |
| (paper) | | | | | | |
| FiD Static | LLM | LLM | 0.2 B | 65.7 | 42.3 | 19.8 |
| FiD Static | top-5- | top-5- | 0.2 B | 65.6 | 42.4 | 20.1 |
| | relevant | retrieval | | | | |
| | news | news | | | | |
| FiD Static | top-5- | top-5- | 0.2 B | 66.3 | 43.5 | 20.0 |
| | relevant | relevant | | | | |
| | news | news | | | | |

Numerical questions entail outputting continuous values, which stands in contrast to the discrete choice tasks of T/F and MCQ. Through empirical analysis, it was observed that jointly training these three tasks can potentially impede performance in one area or another. However, when the numerical questions are segregated within the training set, a noteworthy enhancement results.

TABLE 3
Effects of Splitting Numerical Questions on Model Performance

| Model | Config | Model Size | T/F↑ | MCQ↑ | Num↓ |
|---|---|---|---|---|---|
| FiD Static | — | 0.2 B | 62.0 | 29.6 | 24.5 |
| (paper) | | | | | |
| FiD Static | raw news | 0.2 B | 64.8 | 43.0 | 20.3 |
| FiD Static | summarized | 0.2 B | 65.4 | 42.4 | 19.9 |
| | news | | | | |
| FiD Static | summarized | 0.2 B | 65.9 | 43.1 | n/a |
| | news w/o | | | | |
| | num. | | | | |
| FiD Static | summarized | 0.2 B | n/a | n/a | 20.0 |
| | news w/ | | | | |
| | num. only | | | | |
| FiD Static | summarized | 0.2 B | 65.3 | 42.3 | 20.0 |
| | news w/ | | | | |
| | human label | | | | |
| FiD Static | rel. re-rank + | 0.2 B | 65.5 | 42.1 | 21.3 |
| | sum. news | | | | |
| FiD Static | rel. re-rank + | 0.2 B | 0.2 B | 65.9 | 43.1 |
| | sum. news | | | | |
| | w/o num. | | | | |
| FiD Static | rel. re-rank + | 0.2 B | 0.2 B | n/a | n/a |
| | sum. news | | | | |
| | w/ num. | | | | |
| | only | | | | |

Context size is also relevant to system 100 performance. The context size denotes the quantity of news articles input into the neural network 106 to facilitate future event forecasting. In an ideal scenario, a greater number of articles can offer more information, potentially enhancing performance. However, this choice also entails the trade-off of increased memory requirements and computational resources. To determine the optimal context size, ablation studies were performed, and the outcomes are presented in the subsequent table.

TABLE 4
Effects of News Article Context Size on Model Performance

| Model | Context | Model Size | T/F↑ | MCQ↑ | Num↓ |
|---|---|---|---|---|---|
| FiD Static | raw news | 0.2 B | 62.0 | 29.6 | 24.5 |
| (paper) | | | | | |
| FiD Static | raw news | 0.2 B | 64.8 | 43.0 | 20.3 |
| FiD Static | summarized | 0.2 B | 65.4 | 42.4 | 19.9 |
| | news, ctx@10 | | | | |
| FiD Static | summarized | 0.2 B | 66.0 | 43.1 | 20.7 |
| | news, ctx@30 | | | | |
| FiD Static | summarized | 0.2 B | 65.3 | 39.1 | 21.4 |
| | news, ctx@100 | | | | |
| FiD Static | rel. re-rank + | 0.2 B | 65.5 | 42.1 | 21.3 |
| | sum. news, | | | | |
| | ctx@10 | | | | |
| FiD Static | rel. re-rank + | 0.2 B | 66.0 | 42.8 | 20.7 |
| | sum. news, | | | | |
| | ctx@30 | | | | |
| FiD Static | rel. re-rank + | 0.2 B | 65.3 | 40.2 | 21.3 |
| | sum. news, | | | | |
| | ctx@100 | | | | |
| FiD Static | raw news | 0.8 B | 64.1 | 32.4 | 21.8 |
| (paper) | | | | | |
| FiD Static | raw news | 0.8 B | 65.5 | 33.5 | 21.4 |
| FiD Static | summarized | 0.8 B | 65.8 | 41.0 | 19.8 |
| | news, ctx@10 | | | | |
| FiD Static | summarized | 0.8 B | 66.4 | 43.4 | 19.9 |
| | news, ctx@30 | | | | |
| FiD Static | rel. re-rank + | 0.8 B | 0.8 B | 65.8 | 41.0 |
| | sum. news, | | | | |
| | ctx@10 | | | | |
| FiD Static | rel. re-rank + | 0.8 B | 0.8 B | 66.4 | 43.4 |
| | sum. news, | | | | |
| | ctx@30 | | | | |
| FiD Static | rel. re-rank + | 0.8 B | 0.8 B | 64.2 | 40.1 |
| | sum. news, | | | | |
| | ctx@100 | | | | |

As noted above, the documents 104 may be summarized using an LLM to increase system 100 performance. For example, when the documents 104 comprise news articles, the original news content might contain redundancies or exceed the neural network's 106 token processing limit, posing challenges for the neural network 106 to understand the relation between questions 102 and context news. Rather than resorting to increasing the neural network's 106 size, employing pre-trained LLMs to condense the news articles can yield a significant performance improvement. Table 5 evidences this.

TABLE 5
Effects of News Articles Summarization on Model Performance

| Model | Summarization | Model Size | T/F↑ | MCQ↑ | Num↓ |
|---|---|---|---|---|---|
| FiD Static (paper) | n/a | 0.2 B | 62.0 | 29.6 | 24.5 |
| FiD Static | raw news | 0.2 B | 64.8 | 43.0 | 20.3 |
| FiD Static | sum. w. llama2 | 0.2 B | 65.4 | 42.4 | 19.9 |
| FiD Static | sum. w. gpt- | 0.2 B | 65.7 | 42.3 | 19.8 |
| | 3.5-turbo | | | | |

Removing noisy data was also tested as a way to increase system 100 performance, as described above. The significance of the quality of documents 104 in the form of news articles appended to each question 102 is paramount in facilitating accurate predictions. In empirical investigation, it was ascertained that the implementation of a filtration mechanism, which eliminates less-relevant news articles based on retrieval scores, can result in performance enhancements, even though it may entail a reduction in the overall number of training instances. Nevertheless, the inclusion of noisy or irrelevant news articles may have a counterproductive effect, potentially leading to confusion rather than bolstering the neural network's 106 capacity. This underscores the imperative nature of meticulous pre-processing procedures and the necessity of guiding the model to focus its attention on informative news sources.

TABLE 6
Effects of Removing Noisy Data on Model Performance

| | Score | | | | |
|---|---|---|---|---|---|
| Model | Threshold | Model Size | T/F↑ | MCQ↑ | Num↓ |
| FiD Static (paper) | n/a | 0.2 B | 62.0 | 29.6 | 24.5 |
| FiD Static | 0.0 | 0.2 B | 62.1 | 29.3 | 22.2 |
| FiD Static | 0.5 | 0.2 B | 64.8 | 43.0 | 20.3 |

Also as described above, including numerical questions in joint training alongside True/False (T/F) and Multiple-Choice Questions (MCQ) can result in a decrease in performance when compared to excluding numerical questions. This performance degradation primarily arises from the fact that numerical questions necessitate continuous values as outputs, a domain where language models exhibit limitations.

To address this challenge, a solution was tested involving the discretization of numerical values by introducing ten bins to segment the original values within the range of [0, 1]. This transformation converts the numerical regression task into a classification task, similar to that of MCQs. At a granularity of ten bins, it was observed that the approximation error was negligible, not exceeding 0.03 in both the training and testing sets when bin selection was executed correctly. Employing this method, it was demonstrated that joint training can effectively harmonize all three tasks, resulting in further improvements in performance.

TABLE 7
Effects of Binning Numerical Questions on Model Performance

| Model | Config | Model Size | T/F↑ | MCQ↑ | Num↓ |
|---|---|---|---|---|---|
| FiD Static (paper) | — | 0.2 B | 62.0 | 29.6 | 24.5 |
| FiD Static | Summarized | 0.2 B | 65.7 | 42.3 | 19.8 |
| | news | | | | |
| FiD Static | +discrete | 0.2 B | 65.5 | 42.4 | 18.5 |
| | num. | | | | |
| FiD Static | rel. re-rank + | 0.2 B | 65.5 | 42.1 | 21.3 |
| | sum. news | | | | |
| FiD Static | rel. re-rank + | 0.2 B | 65.9 | 43.1 | n/a |
| | sum. news | | | | |
| | w/o num. | | | | |
| FiD Static | rel. re-rank + | 0.2 B | n/a | n/a | 20.0 |
| | sum. news | | | | |
| | w/ num. | | | | |
| | only | | | | |

LLMs may be used for selection or ranking of the documents 104, as described above. Tables 8-10 provide an analysis of ChatBot responses in the context of addressing Autocast questions and assessing the relevance of documents 104 in the form of news articles. This experimental approach involved the utilization of two versions of ChatGPT™, namely, the GPT-3.5 Turbo™ and GPT-4™ models, which are accessed through the OpenAI™ API. The findings below are based on two data subsets, the complete training set, and a subset consisting of the initial 1,000 True/False questions and the first 300 Multiple-Choice Questions (MCQs).

Numerical predictions are omitted from this analysis due to the inherent difficulty and limitations associated with predicting continuous values using pre-trained general-purpose LLMs. Such a task presents substantial challenges and is likely to yield unsatisfactory results.

TABLE 8
ChatGPT ™ Response Accuracy

| Model | Context | T/F↑ | MCQ↑ |
|---|---|---|---|
| gpt-3.5-turbo | no-news | 1705/3180 = 53.6% | 239/744 32.1% |
| gpt-3.5-turbo | top-1-news | 1673/3180 = 52.6% | 254/744 34.2% |
| gpt-3.5-turbo | no-news | 543/1000 = 54.3% | 102/300 34.0% |
| gpt-3.5-turbo | top-1-news | 537/1000 = 53.7% | 110/300 36.7% |
| gpt-4 | no-news | 587/1000 = 58.7% | 112/300 37.3% |
| gpt-4 | top-1-news | 547/1000 = 54.7% | 108/300 36.0% |

TABLE 9
ChatGPT ™ response accuracy (majority voting)
in the news relevance assessment

| Model | Context | T/F↑ | MCQ↑ |
|---|---|---|---|
| gpt-3.5-turbo | no-news | 1705/3180 = 53.6% | 239/744 32.1% |
| gpt-3.5-turbo | top-1-news | 1673/3180 = 52.6% | 254/744 34.2% |
| gpt-3.5-turbo | top-5-news | 1701/3180 = 53.5% | 260/744 34.9% |
| gpt-3.5-turbo | top-1-news | 1902/3180 = 53.7% | 272/744 36.6% |

TABLE 10
ChatGPT ™ end-to-end relevance assessment (scale is
for 1 to 5 and averaged for all articles).

| Model | Context | T/F↑ | MCQ↑ | Num↓ |
|---|---|---|---|---|
| gpt-3.5-turbo | top-1-news | 2.1 | 1.9 | 1.3 |
| gpt-3.5-turbo | top-5-news | 2.3 | 2.0 | 1.4 |
| gpt-3.5-turbo | top-10-news | 2.8 | 2.5 | 1.7 |

Table 10 in particular shows the assessment results for news relevance concerning various question types and different numbers of context news articles. The relevance measure is averaged across all questions of a given type over all retrieved articles (top-K news, with K=1/5/10). Forecasting accuracy is not depicted in Table 10.

As mentioned above, a pre-trained language model, specifically ChatGPT™, was used to gauge the relevance between the forecasting question and the retrieved articles. The prompt used was, “Please evaluate the relevance between the news and the article on a scale from 1 to 5, with 5 being the most relevant.” This method is chosen because quantifying relevance using continuous values is challenging for language models. Consequently, discrete labels were used.

The performance of the system 100 was also analyzed using three different model sizes. The results are shown below in Table 11, where “example” corresponds to the system 100. In particular, there is a substantial performance boost, notably for smaller models.

TABLE 11
Performance results over different model sizes

| | | | | | |
|---|---|---|---|---|---|
| Model | Full Context Length | Model Size | T/F↑ | MCQ↑ | Num.↓ |

Small-size Models

| | | | | | |
|---|---|---|---|---|---|
| UnifiedQA (Khashabi et al., 2022) | n/a | 0.2 B | 45.4 | 23.5 | 34.5 |
| T5 (Raffel et al., 2020) | n/a | 0.2 B | 61.3 | 24.0 | 20.5 |
| FiD Static (Zou et al., 2022) | 10 | 0.2 B | 62.0 | 29.6 | 24.5 |
| FiD Temporal (Zou et al., 2022) | query-specific | 0.6 B | 62.0 | 33.5 | 23.9 |
| Example | 10 | 0.2 B | 66.7 | 43.8 | 19.8 |

Middle-size Models

| | | | | | |
|---|---|---|---|---|---|
| UnifiedQA (Khashabi et al., 2022) | n/a | 0.8 B | 48.2 | 23.5 | 34.5 |
| T5 (Raffel et al., 2020) | n/a | 0.8 B | 60.0 | 29.1 | 21.7 |
| FiD Static (Zou et al., 2022) | 10 | 0.8 B | 64.1 | 32.4 | 21.8 |
| FiD Temporal (Zou et al., 2022) | query-specific | 1.5 B | 63.8 | 32.4 | 21.0 |
| Example | 10 | 0.8 B | 67.3 | 44.0 | 19.9 |

Large-size Models

| | | | | | |
|---|---|---|---|---|---|
| UnifiedQA (Khashabi et al., 2022) | n/a | 2.8 B | 54.9 | 25.1 | 34.5 |
| T5 (Raffel et al., 2020) | n/a | 2.8 B | 60.0 | 26.8 | 21.9 |
| FiD Static (Zou et al., 2022) | 10 | 2.8 B | 65.4 | 35.8 | 19.9 |
| FiD Temporal (Zou et al., 2022) | query-specific | 4.3 B | 62.9 | 36.9 | 19.5 |
| Example | 10 | 2.8 B | 67.9 | 44.1 | 19.8 |

As shown, the compact models of the example embodiment, such as the 0.2B and 0.8B variants, already surpass larger baselines like the FiD Static with 2.8B parameters. This suggests that model size may not be the primary determinant for generating correct prediction outcomes. In a similar vein, it is observed that the performance boost from utilizing more extensive models is less remarkable. For instance, the 2.8B parameter model of the example embodiment marginally outperforms the 0.2B model for T/F and MCQ, yet delivers identical outcomes for numerical predictions. While the 4.3B parameter FiD Temporal baseline achieves the best performance in numerical prediction, it is significantly larger and more computationally intensive to train. This is because it processes news articles for each day within the active period of the question, which averages 130 days in the Autocast dataset. Consequently, its retriever deals with a considerably larger volume of news articles. However, FiD Temporal does not perform satisfactorily on T/F and MCQ questions in contrast to the example embodiment. This highlights importance of effectively extracting relevant information from news articles, rather than indiscriminately processing all available data.

The effects of different implementations of various features were also tested. Ablation studies were conducted in comparison to the FiD Static model. In the context of retrieval of documents, FiD Static integrates the BM25 retriever enhanced with cross-encoder re-ranking. The architecture of both the FiD Static and the system 100's neural network 106 can be similar. However, the former does not comprise the use of self-attention module tailored for the human alignment loss and the training loss for binning numerical question. By implementing modifications progressively, improvements are seen in the FiD Static, thus facilitating an evaluation of the incremental performance benefits of each component, shown below in Table 12, where “example” corresponds to the example embodiment of system 100. In Table 12, ablation experiments utilizing the 0.2B model size, with the baseline model being the vanilla FiD Static. To ease exposition, FiD Static with numerical question binning is named FiD Static*. Distinct markers are used to differentiate between various ablations: 1 represents experiments on LLM-enhanced components, 2 denotes experiments on numerical question binning, and 3 indicates experiments on alignment loss.

TABLE 11
Performance results of different retriever and system components

| | Retriever Component | | Reader Component | | | | | |
|---|---|---|---|---|---|---|---|---|
| | Zero-shot | Recency | Zero-shot | Binning Num. | Alignment | Metrics | | |
| Model | Relevance Re-rank | Re-rank | Sum. | Questions | Loss | T/F↑ | MCQ↑ | Num↓ |
| FiD Static | X | X | X | X | X | 62.0 | 29.6 | 24.5 |
| 1 FiD Static + rel. re-rank & sum. | ✓ | X | ✓ | X | X | 65.5 | 42.1 | 21.3 |
| 3 FiD Static + alignment | X | X | X | X | ✓ | 62.5 | 31.2 | 23.5 |
| 2 FiD Static* | X | X | X | i | X | 62.1 | 29.6 | 23.2 |
| 1 FiD Static* + sum. | X | X | ✓ | ✓ | X | 65.7 | 42.3 | 19.8 |
| 1 FiD Static* + rel. re-rank | ✓ | X | X | ✓ | X | 64.7 | 39.8 | 21.2 |
| 1 FiD Static* + full retriever | ✓ | ✓ | X | ✓ | X | 65.8 | 42.4 | 20.2 |
| 2 Example w/o binning | ✓ | ✓ | ✓ | X | ✓ | 66.7 | 43.6 | 21.0 |
| 3 Example w/o alignment | ✓ | ✓ | ✓ | ✓ | X | 66.7 | 43.5 | 19.9 |
| Example (full) | ✓ | ✓ | ✓ | ✓ | ✓ | 66.7 | 43.8 | 19.8 |

As shown in Table 12, LLM enhancement (1), particularly the zero-shot relevance re-ranking and text summarization techniques, facilitated by a pre-trained LLM, stand out as the most effective. Implementing these techniques in FiD Static or FiD Static*baselines significantly improves performance across various question types, with a marked enhancement in MCQ accuracy, elevating their performance. Binning numerical questions (2) to transform the regression task in a continuous space into a classification problem can be useful in that the same cross-entropy loss used for T/F and MCQ can be implemented. Empirically, this method generally enhances the performance of numerical questions without adversely affecting other question types. Although its impact on overall metrics is less significant, it can complement the LLM enhancement components. The alignment loss (3) leverages human crowd forecasting results to regulate the text encoder representations, thereby simulating the progression of information and knowledge over time. This alignment loss can be particularly beneficial for the basic FiD Static baseline, which lacks any LLM-enhanced components. However, when relevance re-ranking and text summarization are employed, the alignment loss appears to have a diminished role in enhancing performance.

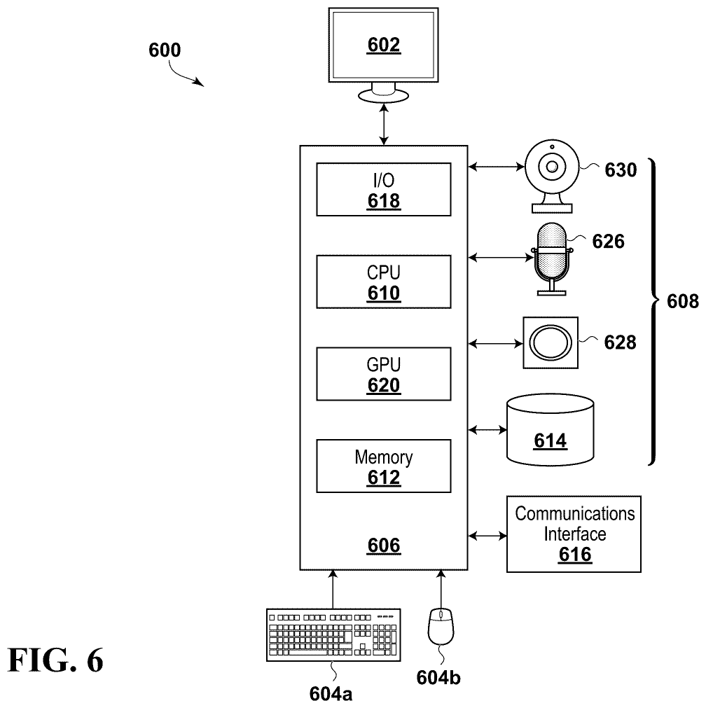

An example computer system in respect of which the system 100 described above may be implemented is presented as a block diagram in FIG. 6. The example computer system is denoted generally by reference numeral 600 and includes a display 602, input devices in the form of keyboard 604a and pointing device 604b, computer 606 and external devices 608. While pointing device 604b is depicted as a mouse, it will be appreciated that other types of pointing device, or a touch screen, may also be used.

The computer 606 may contain one or more processors or microprocessors, such as a central processing unit (CPU) 610. The CPU 610 performs arithmetic calculations and control functions to execute software stored in a non-transitory internal memory 612, preferably random access memory (RAM) and/or read only memory (ROM), and possibly storage 614. The storage 614 is non-transitory may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This storage 614 may be physically internal to the computer 606, or external as shown in FIG. 6, or both. The storage 614 may also comprise a database for storing a set of images as described above. For example, the datasets used in the experiments described above may be stored in such a database and retrieved for use in training.

The one or more processors or microprocessors may comprise any suitable processing unit such as an artificial intelligence accelerator, programmable logic controller, a microcontroller (which comprises both a processing unit and a non-transitory computer readable medium), AI accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

Any one or more of the methods described above may be implemented as computer program code and stored in the internal memory 612 and/or storage 614 for execution by the one or more processors or microprocessors to effect neural network pre-training, training, or use of a trained network for inference.

The computer system 600 may also include other similar means for allowing computer programs or other instructions to be loaded. Such means can include, for example, a communications interface 616 which allows software and data to be transferred between the computer system 600 and external systems and networks. Examples of communications interface 616 can include a modem, a network interface such as an Ethernet card, a wireless communication interface, or a serial or parallel communications port. Software and data transferred via communications interface 616 are in the form of signals which can be electronic, acoustic, electromagnetic, optical or other signals capable of being received by communications interface 616. Multiple interfaces, of course, can be provided on a single computer system 600.

Input and output to and from the computer 606 is administered by the input/output (I/O) interface 618. This I/O interface 618 administers control of the display 602, keyboard 604a, external devices 608 and other such components of the computer system 600. The computer 606 also includes a graphical processing unit (GPU) 620. The latter may also be used for computational purposes as an adjunct to, or instead of, the CPU 610, for mathematical calculations.

The external devices 608 include a microphone 626, a speaker 628 and a camera 630. Although shown as external devices, they may alternatively be built in as part of the hardware of the computer system 600. For example, the camera 630 and microphone 626 may be used to retrieve multi-modal content for use in training or at inference/test-time.

The various components of the computer system 600 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Phrases such as “at least one of A, B, and C”, “at least one of A, B, or C”, “one or more of A, B, and C”, and “A, B, and/or C” are intended to include both a single item from the enumerated list of items (i.e., only A, only B, or only C) and multiple items from the list (i.e., A and B, B and C, A and C, and A, B, and C). Accordingly, the phrases “at least one of”, “one or more of”, and similar phrases when used in conjunction with a list are not meant to require that each item of the list be present, although each item of the list may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

### REFERENCES

[1] Edward J Hu, Yelong Shen, Phillip Wallis, Zeyuan Allen-Zhu, Yuanzhi Li, Shean Wang, Lu Wang, and Weizhu Chen. Lora: Low-rank adaptation of large language models. arXiv preprint arXiv: 2106.09685, 2021.
[2] Andy Zou, Tristan Xiao, Ryan Jia, Joe Kwon, Mantas Mazeika, Richard Li, Dawn Song, Jacob Steinhardt, Owain Evans, and Dan Hendrycks. Forecasting future world events with neural networks, 2022.
[3] Common Crawl-Open Repository of Web Crawl Data—commoncrawl.org. https://commoncrawl.org.

1. A method for performing event prediction, the method comprising:
receiving an event prediction query;
retrieving a plurality of documents comprising information pertaining to the event prediction query, each of the plurality of the documents classified on a relevance thereof to the event prediction query;
generating an input vector with the event prediction query and the plurality of documents classified on relevance;
processing the input vector with a neural network trained to determine an event prediction outcome corresponding to a response to the event prediction query; and
generating the event prediction outcome of the event prediction query with the neural network.

2. The method of claim 1, further comprising:
processing the plurality of documents and the event prediction query with a first large language model to classify the plurality of documents based on relevance by generating, with the first large language model, a relevance score for each document of the plurality of documents to determining the relevance of each document;
wherein the plurality of documents included in the input vector comprises a subset of relevant documents selected from the plurality of documents based on the relevance score.

3. The method of claim 1, wherein the event prediction outcome is a numerical response or a non-numerical response; and wherein the non-numerical response corresponds to a multiple-choice answer or a true or false answer.

4. The method of claim 1, wherein the event prediction query comprises:
a text-based event prediction question;
a plurality of possible event prediction outcomes; and
an event prediction period corresponding to a start time and an end time defining a valid duration based on which the event prediction outcome is generated.

5. The method of claim 1, wherein the event prediction outcome is discretized into to one of a plurality of binned groups of numerical values and wherein the event prediction outcome corresponds to one of a plurality of midpoints of the plurality of binned groups.

6. The method of claim 2, wherein the relevance score corresponds to one of a plurality of integer bins representing the relevance of each document.

7. The method of claim 2, wherein the first large language model processes the plurality of documents and the event prediction query over a number of iterations to generate a plurality of relevance scores for each document and wherein the relevance score of each document is based on the plurality of relevance scores.

8. The method of claim 2, further comprising:
augmenting the relevance score with a recency score,
wherein the recency score is determined based on a time associated with each document.

9. The method of claim 2, wherein the subset of relevant documents is selected based on a threshold relevance score.

10. The method of claim 1, wherein each of the plurality of documents comprises a summary thereof generated with a second large language model.

11. The method of claim 1, wherein the neural network is tuned using low-rank adaptation of large language models architecture.

12. The method of claim 1, wherein the neural network is trained using a loss function comprising a decoder loss corresponding to accuracy of the event prediction outcome and an alignment loss corresponding to confidence in human temporal prediction.

13. The method of claim 1, wherein the plurality of documents are news articles.

14. A method of training at least one neural network for performing event prediction, the method comprising:
obtaining a training dataset comprising:
event prediction queries and a plurality of documents comprising information pertaining to the event prediction queries as inputs; and
event prediction outcomes corresponding to responses to the event prediction queries as ground-truths; and
training a neural network to determine the event prediction outcomes using the training dataset;
wherein the plurality of documents comprises documents classified on a relevance thereof to the event prediction query.

15. The method of claim 14,
wherein the plurality of documents and the event prediction query are processed by a first large language model to classify the plurality of documents based on relevance by generating, with the first large language model, a relevance score for each document of the plurality of documents to determining the relevance of each document;
wherein the plurality of documents included in the training dataset comprises a subset of relevant documents from the plurality of documents determined based on the relevance score; and
wherein the subset of relevant documents is determined based on a threshold relevance score.

16. The method of claim 14, wherein each of the plurality of documents comprises a summary thereof generated with a second large language model.

17. The method of claim 14, further comprising:
sorting the training dataset based on the event prediction outcomes being numerical responses or non-numerical responses;
wherein the training dataset comprises the sorted training dataset; and
wherein the non-numerical responses corresponds to multiple-choice responses or true or false responses.

18. The method of claim 14, further comprising:
training the neural network to generate the event prediction outcomes as discretized numerical values corresponding to binned groups,
wherein the numerical values are midpoints of the binned groups; and
wherein the each of the event prediction outcomes corresponds to one of a plurality of possible event prediction outcomes.

19. The method of claim 14, further comprising:
training the neural network using a loss function comprising a decoder loss corresponding to accuracy of event prediction outcome and an alignment loss corresponding to confidence in human temporal prediction.

20. A system for performing event prediction, the system comprising one or more processing units configured to perform a method comprising:
receiving an event prediction query;
retrieving a plurality of documents comprising information pertaining to the event prediction query, each of the plurality of the documents classified on a relevance thereof to the event prediction query;
generating an input vector with the event prediction query and the plurality of documents classified on relevance;
processing the input vector with a neural network trained to determine an event prediction outcome corresponding to a response to the event prediction query; and
generating the event prediction outcome of the event prediction query with the neural network.
